(19) United States
(12) Patent Application Publication
(10) Pub. No.: US 2007/0173363 A1
(43) Pub. Date: Jul. 26, 2007

(54) Electromotive actuating drive

(76) Inventors: Bernd Buchholz, Rahden (DE); Dieter Palm, Werther (DE)

Correspondence Address: BARNES & THORNBURG LLP, 750-17TH STREET NW, SUITE 900, WASHINGTON, DC, 20006-4675, US

(21) Appl. No.: 11/652,066

(22) Filed: Jan. 11, 2007

Related U.S. Application Data
(60) Provisional application No. 60/760,395, filed on Jan. 20, 2006.

(30) Foreign Application Priority Data
Jan. 20, 2006 (DE) 20 2006 000 966.3

(51) Int. Cl. B62J 13/00; F16H 7/08; F16H 57/02

(52) U.S. Cl. 474/144; 474/101

(57) ABSTRACT

An electromotive actuating device for swivellable actuators includes a housing having driving parts of a transmission train mounted therein. The transmission train is configured to be driven by a driving motor. An output member is assigned to the housing. A centering tensioning device is assigned to the output member. The centering tensioning device includes two oppositely moveable tensioning elements configured to tension a transmission shaft fixedly connected to an actuator. The centering tensioning device is configured to be synchronously swiveled with the output member with respect to the housing. A swiveling angle of the tensioning device is limited by stationarily acting stops that are adjustably and fixably arranged at the housing.

### CROSS REFERENCE

This is an application claiming priority to and benefit of U.S. Provisional Application No. 60/760,395, filed on Jan. 20, 2006 and German Patent Application Number 20 2006 000 966.3 filed Jan. 20, 2006 in Germany, the subject matter of each being incorporated by reference herein.

### BACKGROUND AND SUMMARY

The present disclosure relates to an electromotive actuating drive for swivellable actuators. The drive includes a housing in which the driving parts of a transmission chain are mounted. The transmission chain can be driven by a driving motor. The transmission is equipped with an output member to which a centering tensioning device having two oppositely movable tensioning elements for tensioning a transmission shaft fixedly connected with the actuator is assigned. The tensioning device can be swiveled synchronously with the output member of the transmission chain with respect to the housing of the transmission chain. A swiveling angle of the tensioning device is limited by stationarily acting stops which are adjustably as well as fixably arranged at the housing of the transmission chain.

The electromotive actuating drive is particularly suitable for swivellable actuators in the form of flaps in the heating, air-conditioning and ventilating field. The swiveling angle can be set by the adjustable stops and, in the normal implementation, amounts to maximally 95°. The rotational speed of the driving motor is relatively high, so that the transmission chain has several transmission stages because the rotational speed of the output member is clearly lower. The output member transmission transmits the rotating movement to the actuator by the transmission shaft.

The tensioning device is designed such that different cross-sections and dimensions of the transmission shafts can be tensioned. In this case, a centering is required so that a deformation of the actuating drive and/or of the transmission shaft is avoided.

The tensioning devices are designed such that the tensioning of the transmission shaft takes place in a simple manner. For this purpose, each tensioning device is equipped with two tensioning elements movable in opposite directions. This movement is derived from a differential screw which is equipped with two opposite threads of an equal or unequal pitch.

The electromotive actuating drives have been very successful in practice. However, the driving motor will not be switched off before the motor current exceeds a certain intensity. For example, when the tensioning device moves against the stop, a movement can no longer take place, so that the intensity of the current rises. However, this results in an additional loading of the driving motor, whereby the service life is reduced. It is also considered to be a disadvantage that, after the tensioning device runs against a stop, the transmission chain is stressed in a shock-type manner. In order to avoid a fracturing or damaging of drive components, the transmission chain is designed for torques not necessary for adjusting the actuator. In other words, the transmission chain is overdimensioned, which not only increases the manufacturing costs but also results in unnecessarily large dimensions.

The present disclosure relates to an electromotive actuating drive such that, while a relatively low safety factor is maintained, the transmission chain is designed only for a torque necessary for adjusting the actuator.

The present disclosure further relates to an electromotive actuating drive including spring elements that are placed on the tensioning device, which move against stops which are adjustable but can be fixed and/or the stops are constructed in a resilient manner.

In accordance with the present disclosure, the shock-type stressing of the transmission chain is avoided. In such a case, it is sufficient for the spring elements to be placed on the tensioning device, for example, to the housing of the tensioning device, or for the stops themselves to have a resilient or flexible construction. The motor current is therefore not increased suddenly but is increased over a defined period of time. Or analogously, the movement of the tensioning device is braked with respect to the housing of the transmission chain. This leads to a soft running of the spring elements against the stops or of a rigid element against the resilient stops. However, by combining the spring elements with the resilient stops, the running against the stops is extremely soft. Since the transmission chain is designed for the torque required for the adjustment of the actuator, either, in a first case, the dimensions of the transmission chain are reduced, or, in a second case, drive components can be used which have a lower stability. In the first case, the dimensions are reduced, so that an extremely compact construction is obtained. In the second case, the manufacturing costs are reduced because of the less expensive materials.

In an embodiment of the present disclosure, it is provided that the housing accommodating the transmission chain has a step-shaped construction on the side facing away from the driving motor. In addition, the tensioning device is arranged in the recess and can be swiveled about the axis of rotation of the output member of the transmission chain. Since the overall height of the tensioning device is clearly lower than the housing part arranged next to it, the tension device does not protrude beyond the mentioned part of the housing, so that the overall construction is compact. On the side facing away from the driving motor, the housing is step-shaped on both sides.

In a standard construction, the output member of the transmission chain is a sleeve. With respect to the stepped housing, the sleeve protrudes on the side situated opposite the tensioning device. The housing of the tensioning device also has a two-part construction and consists of a top part and a bottom part, which are mutually connected by two screws situated symmetrically with respect to the axis of rotation of the tensioning device. Oblong holes for the adjustment of the stops are provided in a wall of the stepped housing part of the transmission chain. So that the spring elements also run against the stops at each angle of rotation of the tensioning device, the present disclosure provides for the oblong holes to extend concentrically with respect to the axis of rotation of the tensioning device. It is also provided that springs are placed on a housing part of the tensioning device, which springs run against stops. These springs may be constructed in one piece with the housing part. However, they may also be fastened thereto by mechanical connection elements. The housing parts include a plastic material. With respect to the manufacturing, it is advantageous for the springs to also be injection-molded during the injection molding operation of the housing parts. However, it is also conceivable to subsequently attach metallic springs to the housing part.

So that the spring elements run against the stops in both end positions of the housing, it is provided that the spring elements have a hook-shaped, curved or C-shaped construction. As a result, the movement against the stops in both end positions takes place in the simplest manner.

Other aspects of the present disclosure will become apparent from the following descriptions when considered in conjunction with the accompanying drawings.

### BRIEF DESCRIPTION OF THE DRAWINGS

FIG. 1 is a perspective view of a first part of a housing part of a tensioning device having an output member, according to the present disclosure.

FIG. 2 is a perspective view of a second housing part configured to be connected to the first housing part of FIG. 1.

### DETAILED DESCRIPTION

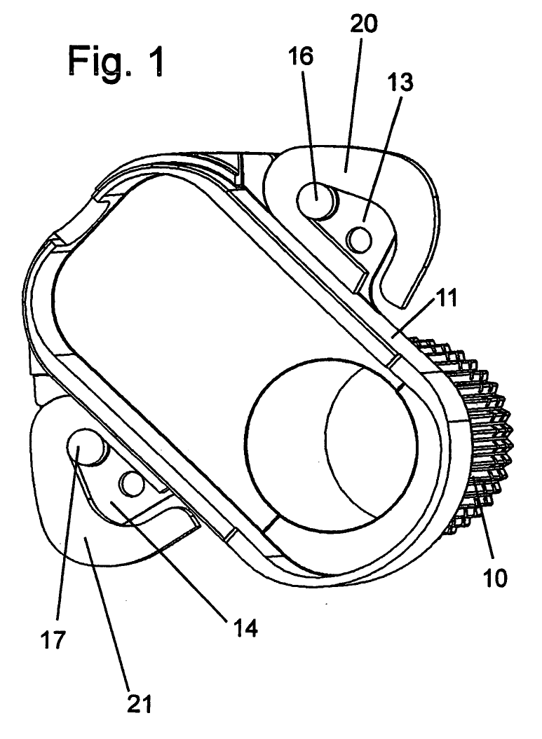

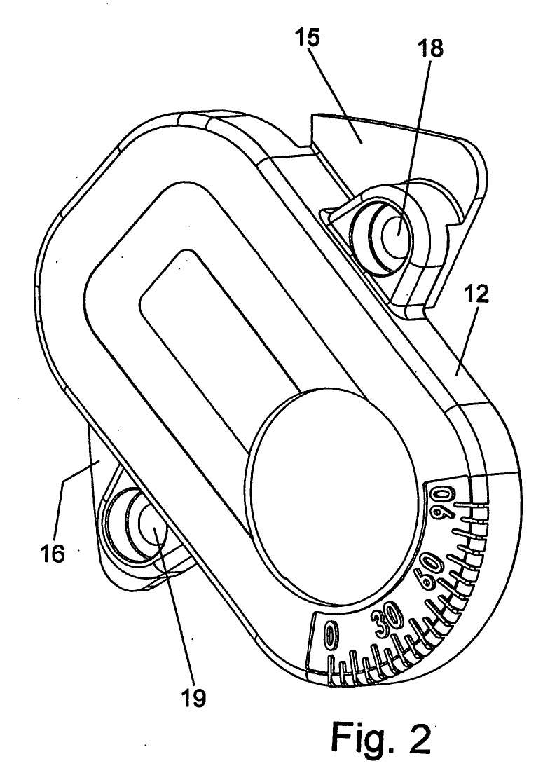

For the purpose of a simplified representation, an electromotive actuating drive is not shown as a whole. A transmission chain includes several transmission stages in order to reduce the rotational speed of a motor driving the transmission chain to such an extent that the adjusting speed or the rotational speed of an actuator to be adjusted corresponds to desired requirements. The transmission chain includes mutually meshing gearwheels. In addition, the transmission chain includes an output member of the actuating drive which, in an illustrated embodiment, is a bushing 10 equipped with external teeth. The bushing 10 is fixedly connected with a housing part 11 in which components of a tensioning device are arranged, (not shown). The tensioning device includes two tensioning elements which can be moved in opposite directions as a result of the rotation of a differential screw, so that a transmission shaft extending through the bushing 10 is tensioned or released. The tensioning device is designed such that different cross-sections and different dimensions of transmission shafts can be tensioned. As suggested in FIG. 1, housing part 11 follows a rotating movement of the bushing 10. As a result, the housing part 11 is also swiveled with respect to a housing of an actuating drive (not shown). The housing part 11 is connected to or screwed to another housing part 12 by screws (not shown). For this purpose, flanges 13, 14 are molded laterally to housing part 11, and flanges 15, 22 are molded laterally to housing part 12. Screw holes 16, 17 are provided in the flanges 13, 14, while cups are also molded to the flanges 15, 22 of the housing part 12 in order to accommodate the heads of cap screws. The screw holes of the flanges 15, 22 have the reference numbers 18, 19. Oblong holes (not shown) are provided in a wall of the housing of the transmission chain, which oblong holes extend concentrically with respect to an axis of rotation of the bushing 10, for fixing stops. As illustrated in FIG. 2, a maximal swiveling angle of the housing parts 11, 12 amounts to maximally 95°. For this purpose, the housing part 12 is provided with a scale. As shown in FIG. 1, resilient spring elements 20, 21 are molded to the housing part 12, which spring elements 20, 21 move against the stops (not shown) of the housing of the transmission chain (not shown) when the aforementioned actuator is moved by the electromotive actuating drive. Analogously, the housing parts 11, 12 are braked in end positions, so that the motor current rises. The switching-off of the aforementioned driving motor will then take place by an overcurrent relay. As illustrated in FIG. 1, the spring elements 20, 21 have a hook-shaped, curved or C-shaped design, so that a movement against the stops takes place in both end positions of the housing parts 11, 12. This results in a constructively simple solution.

By resilient spring elements 20, 21, shocks onto driving parts of the driving chain are avoided. Thus, a careful treatment takes place, permitting the elimination of an overdimensioning. And, these driving parts are designed for the torque required for the adjustment of the actuator. A sufficient safety factor is taken into account.

It is within the scope of the present disclosure for rigid elements to be joined or molded to housing part 11 or 12, and for the stops to have an elastically deformable or resilient design. Furthermore, it is within the scope of the present disclosure that elastically deformable spring elements are joined or molded to housing part 11, 12 and that the stops are also elastic or resilient.

The present disclosure is not limited to the illustrated embodiment. It is important, for example, that spring elements 20, 21 be arranged at least on one housing part 11 or 12, which spring elements 20, 21 prevent a shock-type or blow-type impacting on the fixed but adjustable stops.

Although the present disclosure has been described and illustrated in detail, it is to be clearly understood that this is done by way of illustration and example only and is not to be taken by way of limitation. The scope of the present disclosure is to be limited only by the terms of the appended claims.

The invention relates to an electromotive actuating drive for swivellable actuators, which has a housing in which the driving parts of a drive chain are mounted, which drive chain can be driven by a driving motor and is equipped with an output member to which a centering tensioning device having two tensioning elements, which can be moved in opposite directions, for tensioning a transmission shaft fixedly connected with the actuator, is assigned such that the tensioning device can be swivelled synchronously with the output member of the drive chain with respect to the housing of the drive chain, and the swivelling angle of the tensioning device is limited by stationarily acting stops adjustably as well as fixably arranged at the housing of the drive chain.

The involved electromotive actuating drive is particularly suitable for swivellable actuators in the form of flaps in the heating, air-conditioning and ventilating field. The swivelling angle can be adjusted by the adjustable stops and, in the normal construction, amounts to maximally 95°. The rotational speed of the driving motor is relatively high, so that the drive chain has several transmission steps because the rotational speed of the output member is clearly lower. By means of the transmission shaft, the output member transmits the rotating movement to the actuator.

The tensioning device is designed such that different cross-sections and dimensions of the transmission shafts can be tensioned. In this case, a centering is required so that a distortion of the actuating drive and/or of the transmission shaft is avoided.

The tensioning devices are designed such that the tensioning of the transmission shaft takes place in the simplest manner. For this purpose, each tensioning device is equipped with two tensioning elements movable in opposite directions. This movement is derived from a so-called differential screw which is equipped with two contradirectional threads of an equal or unequal pitch.

The concerned electromotive actuating drives have been very successful in practice. However, the driving motor is not switched off before the motor current exceeds a certain intensity; that is, when the tensioning device moves against the stop, a movement can no longer take place, so that the intensity of the current rises. This results in additional stress to the driving motor, whereby the service life is reduced. Furthermore, it is considered to be a disadvantage that, after the tensioning device runs against a stop, the drive chain is stressed in a shocklike manner. In order to avoid breaking or damaging drive parts, the drive chain is therefore designed for torques which are not necessary for adjusting the actuator or, in other words, the drive chain is overdimensioned, which not only increases the manufacturing costs but also results in unnecessarily large dimensions.

It is an object of the present invention to design an electromotive actuating drive of the initially mentioned type such that, while maintaining a relatively low safety margin, the drive chain is designed exclusively for the type of torque required for adjusting the actuator.

This object is achieved in that spring elements are placed on the tensioning device, which spring elements move against the adjustable but fixable stops and/or that the stops have a resilient construction.

By means of the solution according to the invention, the shocklike stressing of the drive chain is avoided. In this case, it is sufficient for the spring elements to be placed on the tensioning device, particularly on the housing of the tensioning device, or for the stops themselves to have a resilient or elastic construction. As a result, the motor current is not suddenly increased but is increased over a defined time period, or the movement of the tensioning device with respect to the housing of the drive chain is braked correspondingly. This results in a soft running of the spring elements against the stops or of a rigid element against the resilient stops. However, by combining the spring elements with the resilient stops, an extremely light running against the stops is achieved. Since the drive chain is now designed for the torque required for the adjustment of the actuator, either the dimensions of the drive chain are reduced, or drive parts can be used which have a lower stability. In the former case, the dimensions are reduced, so that an extremely compact construction is obtained. In the second case, the manufacturing expenses are decreased as a result of the more cost-effective materials.

In a preferred embodiment, it is provided that the housing accommodating the drive chain is step-shaped on the side facing away from the driving motor, and that the tensioning device is arranged in the step and can be swivelled about the axis of rotation of the output member of the drive chain. Since the overall height of the tensioning device is clearly less than (that of? transl.) the housing part arranged next to it, the tensioning device does not protrude with respect to the above-mentioned part of the housing so that a compact construction is obtained on the whole. The housing is preferably step-shaped on both sides on the side facing away from the driving motor.

In the standard construction, the output member of the drive chain is a sleeve. This sleeve protrudes with respect to the step-shaped housing on the side situated opposite the tensioning device. The housing of the tensioning device is also constructed in two parts and consists of a top part and a bottom part which are mutually connected by two screws situated symmetrically with respect to the axis of rotation of the tensioning device. In a wall of the stepped housing part of the drive chain, oblong holes are provided for adjusting the stops. So that the spring elements also move against the stops at any angle of rotation of the tensioning device, it is provided that the oblong holes extend concentrically with respect to the axis of rotation of the tensioning device. It is further provided that springs moving against the stops are placed on a housing part of the tensioning device. These may be constructed in one piece with the housing part, but may also be fastened there by means of mechanical connecting elements. The housing parts expediently consist of a plastic material. With respect to the manufacturing, it would therefore be advantageous for the springs to also be injection-molded in the course of the injection molding of the housing parts. However, as an alternative, metallic springs can be placed onto the housing part subsequently.

So that the spring elements run against the stops in both end positions of the housing 11, 12, it is provided that the spring elements have a hook-shaped, curved or C-shaped construction. As a result, the movement against the stops takes place in a very simple manner in both end positions.

The invention will be explained in greater detail by means of the attached drawings.

FIG. 1 is a view of the part of the housing of the tensioning device which has the output member; and

FIG. 2 is a view of the housing part which can be screwed to the housing part according to FIG. 1.

For a simplified representation, the electromotive actuating drive is not shown as a whole. The drive chain consists of several transmission steps in order to reduce the rotational speed of the motor driving the drive chain to such an extent that the adjusting speed or the rotational speed of an actuator to be adjusted corresponds to the requirements. The drive chain consists of mutually meshing gears. The drive chain also contains the output member of the actuating drive which, in the illustrated embodiment, is a bush 10 having external teeth. The bush 10 is fixedly connected with a housing part 11 in which the components of a tensioning device are arranged, which tensioning device is not shown for reasons of representation. The tensioning device contains two tensioning elements which can be moved in opposite directions by rotating a so-called differential screw, so that a transmission shaft guided through the bush 10 is tensioned or released. The tensioning device is designed such that different cross-sections and different dimensions of transmission shafts can be tensioned. FIG. 1, in particular, illustrates that the housing part 11 follows the rotating motion of the bush 10. As a result, also housing part 11 is swivelled with respect to the housing of the actuating drive which is not shown. Housing part 11 is screwed to another housing part 12 by means of screws which are not shown. For this purpose, flanges 13, 14 are shaped (can also be translated as “molded”) laterally onto housing part 11, and flanges 15, 16 are shaped laterally onto housing part 12. Screw holes 16, 17 are provided in flanges 13, 14, while cups are shaped (molded?) onto flanges 15, 16 of housing part 12 in order to receive the heads of cylinder head screws. The screw holes of flanges 15, 16 have reference numbers 18, 19. In a manner not shown in detail, oblong holes for fastening stops are provided in a wall of the housing of the drive chain, which oblong holes extend concentrically with respect to the axis of rotation of the bush 10. As shown in FIG. 2, the maximal swivelling angle of housing parts 11, 12 amounts to 95E. For this purpose, housing part 12 is provided with a scale. As illustrated in FIG. 1, resilient spring elements 20, 21 are shaped (molded?) onto the housing part 12, which spring elements 20, 21 move against the stops of the housing of the drive chain when the actuator is moved by the electromotive actuating drive. Correspondingly, a braking takes place in the end positions of the housing 11, 12, so that the motor current rises. The driving motor is then switched off by means of an overload relay. As illustrated in FIG. 1, the spring elements 20, 21 have a hook-shaped, curved or C-shaped design, so that a movement against the stops takes place in both end positions of the housing parts 11, 12. This results in a constructively simple solution.

By means of these resilient spring elements 20, 21, shocks upon the driving parts of the drive chain are avoided so that a careful treatment takes place which may eliminate an overdimensioning, and these driving parts are designed only for the torque required for adjusting the actuator. In this case, a sufficient safety margin is taken into account.

It is also conceivable that rigid elements are placed on or shaped (molded?) to a housing part 11 or 12, and that the stops can be designed to be elastically deformable or resilient. Furthermore, it is also conceivable in a third embodiment that elastically deformable spring elements are placed on or shaped to a housing part and that the stops are also elastic or resilient.

The invention is not limited to the illustrated embodiment. It is important that spring elements 20, 21 are arranged at least on one housing part 11 or 12, which spring elements 20, 21 prevent a shocklike or blowlike impacting onto the stationary but adjustable stops.

1. Electromotive actuating drive for swivellable actuators, which has a housing in which the driving parts of a drive chain are mounted, which drive chain can be driven by a driving motor and is equipped with an output member (10) to which a centering tensioning device having two tensioning elements, which can be moved in opposite directions, for tensioning a transmission shaft fixedly connected with the actuator, is assigned such that the tensioning device can be swivelled synchronously with the output member (10) of the drive chain with respect to the housing of the drive chain, and the swivelling angle of the tensioning device is limited by stationarily acting stops adjustably as well as fixably arranged at the housing of the drive chain, characterized in that spring elements (20, 21) are placed on the tensioning device, which spring elements (20, 21) move against the adjustable but fixable stops, and/or that the stops have a resilient construction.

2. Electromotive actuating drive according to claim 1, characterized in that the housing accommodating the drive chain is step-shaped on the side facing away from the driving motor, and that the tensioning device is arranged in the step and can be swivelled about the axis of rotation of the output member of the drive chain.

3. Electromotive actuating drive according to claim 2, characterized in that the housing accommodating the drive chain is step-shaped on both sides on the side facing away from the driving motor, and that the components of the tensioning device are arranged in a housing.

4. Electromotive actuating drive according to claim 3, characterized in that the housing of the tensioning device consists of two housing parts (11, 12) which are mutually connected by screws situated symmetrically with respect to the axis of rotation of the output member (10).

5. Electromotive actuating drive according to one or more of the preceding claims 1 to 4, characterized in that flanges situated transversely to the axis of rotation of the tensioning device are provided on a housing part (11, 12), on which flanges springs are mounted or placed.

6. Electromotive actuating drive according to one or more of the preceding claims 1 to 5, characterized in that oblong holes in which the stops are fastened are provided in the step-shaped area in the housing receiving the drive chain, which oblong holes extend concentrically with respect to the axis of rotation of the tensioning device.

7. Electromotive actuating drive according to one or more of the preceding claims 1 to 6, characterized in that the spring elements (20, 21) are constructed to be hook-shaped, curved or C-shaped in such a manner that a movement against the stationary but adjustable stops can take place in both end positions of the housing (11, 12).
